(19) United States
(12) Patent Application Publication
(10) Pub. No.: US 2017/0349838 A1
(43) Pub. Date: Dec. 7, 2017

(54) PROCESS FOR PRODUCING SYNTHETIC LIQUID HYDROCARBONS FROM NATURAL GAS

(71) Applicants: Vladimir Zalmanovich MORDKOVICH, Moscow (RU); Infra XTL Technology Limited, Limassol (CY)

(72) Inventors: Vladimir Zalmanovich Mordkovich, Moscow (RU); Vadim Sergeevich Ermolaev, Moscow (RU); Ilia Sergeevich Ermolaev, Moscow (RU)

(21) Appl. No.: 15/540,016

(22) PCT Filed: Dec. 25, 2015
(86) PCT No.: PCT/RU2015/000927

§ 371 Date: Jun. 26, 2017

(30) Foreign Application Priority Data
Dec. 26, 2014 (RU) 2014153237

(51) Int. Cl. C10G 2/00; C01B 3/52; C01B 3/40; C01B 3/50

(52) U.S. Cl. CPC C10G 2/332; C01B 3/503; C01B 3/52; C01B 3/40; C01B 2203/0475; C01B 2203/0405; C01B 2203/0233; C01B 2203/062; C01B 2203/1058; C01B 2203/1241; C01B 2203/0415

(57) ABSTRACT

A process synthesizes C₅ and higher hydrocarbons from natural gas through intermediate conversion of natural gas to synthesis gas and subsequent conversion of CO and H₂ by Fischer-Tropsch synthesis. The process includes steam reforming of natural gas in a steam reforming reactor to form synthesis gas, separating carbon dioxide from the synthesis gas by a liquid absorption method to a residual carbon dioxide content in the synthesis gas no more than 5 vol. %, separating an excess of hydrogen from the synthesis gas by a hydrogen-permeable membrane apparatus to a H₂:CO molar ratio in the range of 1.9 to 2.3 and synthesizing liquid hydrocarbon from the synthesis gas by Fischer-Tropsch synthesis.

### FIELD OF THE INVENTION

The invention relates to the field of gas chemistry, particularly to a process for synthesizing C₅ and higher hydrocarbons from natural gas through intermediate conversion of natural gas to synthesis gas (CO/H₂ mixture) and subsequent conversion of CO and H₂ by Fischer-Tropsch synthesis.

### BACKGROUND OF THE INVENTION

The Fischer-Tropsch process developed in the last century and immediately applied in industry was at first realized by fixed-bed catalytic reactors and then by reactors of ever-more complicated design. It was caused by requirements of increase in catalyst productivity and by needs of solution of rising problems in heat removing.

The Fischer-Tropsch synthesis is an exothermic process and occurs at elevated pressure in the presence of catalysts based on metals of group VIII of the Mendeleev periodic table.

High-pressure synthesis gas for carrying out the Fischer-Tropsch synthesis is produced by oxidation conversion of natural gas hydrocarbons including steam reforming methods, autothermal reforming methods and partial oxidation methods. Herewith, the steam reforming method is a preferred one as it needs no oxygen and is only based on reaction of natural gas with water steam at elevated temperature. It is important that steam reforming is an endothermic process that occurs inside reaction tubes over catalyst, and heat required for carrying out the reaction is provided by combustion of fuel gas in a shell side of a fuel gas reactor wherein fuel gas can be natural gas or any combustible gas.

However, none of the oxidation conversion methods yields synthesis gas fully meeting requirements of Fischer-Tropsch synthesis. Particularly, the H₂:CO molar ratio should be adjusted (it should be near to 2) and CO₂ consent should be corrected (it should be as low as possible for improvement of efficiency of a Fischer-Tropsch reactor). Coordination of synthesis gas composition with the requirements of Fischer-Tropsch synthesis (synthesis gas conditioning) can be implemented by various methods.

In the course of occurring the main process stream “natural gas—conditioned synthesis gas—Fischer-Tropsch synthesis product”, there are involved processes producing additional gas streams such as off gases from Fischer-Tropsch process. Effectiveness of the integrated technique of C₅ and higher hydrocarbon synthesis from natural gas (in terms of kilograms of produced liquid hydrocarbons per 1,000 cubic meters of natural gas or in percentage of carbon efficiency) depends on how these additional streams utilized as process gases or fuel gases. Unfortunately, any methods that are being in use to improve of carbon efficiency result in increase of equipment costs and extra expenses for gas compression.

Improvement of carbon efficiency of the integral technique of C₅ and higher hydrocarbon synthesis with no considerable increase of equipment costs is an important problem.

Known in the art is a process for producing liquid hydrocarbons from natural gas (I. S. Ermolaev, V. S. Ermolaev, V. Z. Mordkovich. Justification of Selection of Circulating Schemes in Synthesis of Liquid Hydrocarbons from Natural Gas. Theoretical Foundations of Chemical Technology, 2013, Vol. 47, No. 2, p.p. 201-201), comprising steam reforming natural gas, separating CO₂ from synthesis gas by an absorption method with amine solution, separating additional CO₂ from combustion gas of steam reforming, combining two streams of the separated CO₂, compressing all the combined CO₂ to a steam reforming pressure and feeding the compressed CO₂ in a tube side of a steam reforming reactor. Such feeding CO₂ in the tube side of the steam reforming reactor enables to shift reforming reaction equilibrium to achieve the required H₂:CO molar ratio. Therefore, the steam reforming of the known process yields synthesis gas having the required H₂:CO molar ratio of 2 and high content of CO₂ that is then removed by amine treatment. After amine treatment, synthesis gas is directly fed to a Fischer-Tropsch reactor where synthetic liquid hydrocarbons are produced from synthesis gas and off-gases of Fischer-Tropsch synthesis is fed to steam reforming burners as fuel gas to partially replace natural gas. High carbon efficiency is an advantage of this known process. A drawback of this process is substantially increased equipment costs because, for providing such high carbon efficiency, separation of the additional CO₂ from combustion gas is necessary to achieve the required H₂:CO molar ratio. Separation of the additional CO₂ from combustion gas involves use of large, unwieldy and expensive apparatus because combustion gas should previously be cooled, CO₂ separation is carried out under adverse conditions of low pressure and low CO₂ content, and oxygen should be removed from rich amine solution and separated CO₂.

The prior art closest to the present invention is a process disclosed in U.S. Pat. No. 6,881,394 B2, 2005 (the process is schematically depicted in FIG. 2). According to the process, natural gas undergoes steam reforming to produce synthesis gas containing an excess amount of hydrogen relative to the required H₂:CO molar ratio of 2. The excess hydrogen is removed from synthesis gas by passing of hydrogen over hydrogen-permeable membranes and then used as fuel gas to maintain the endothermic steam reforming reaction. An advantage of this known process is that the required H₂:CO molar ratio is adjusted by using a simple and inexpensive membrane apparatus.

On the other hand, the main disadvantage of this known process is that its use results in high loss in carbon efficiency of the integrated technique. Substantial decrease of carbon efficiency is due to the fact that large amount of hydrogen, which is the most valuable and hardly separable product of steam reforming (very much energy previously consumed to compress hydrogen has to be sacrificed for hydrogen separation), is inefficiently used as low-pressure fuel gas. Other disadvantage of the know process is that it is impossible to produce synthesis gas having CO₂ content substantially less than 5% in order to use the synthesis gas in Fischer-Tropsch synthesis when the presence of CO in an amount of 5% and especially more substantially inhibits Fischer-Tropsch reaction and decreases process efficiency in whole.

### SUMMARY OF THE INVENTION

A technical object of the present invention is providing a synthesis gas production process free from the disadvantages of the above-mentioned known processes, i.e. producing synthesis gas of optimal composition without the use of CO₂ separation from combustion gas of steam reforming and by ensuring possibility of decreasing CO₂ content in synthesis gas fed to a Fischer-Tropsch reactor substantially lower than 5%.

Said object is accomplished in the present invention by that a process for producing of synthetic liquid hydrocarbons from natural gas comprises subsequent steps of:

steam reforming of natural gas in a steam reforming reactor to form synthesis gas;

separating carbon dioxide from the synthesis gas by a liquid absorption method to provide a residual carbon dioxide content in the synthesis gas no more than 5 vol. %;

separating an excess of hydrogen from the synthesis gas by using a hydrogen-permeable membrane apparatus to provide a H₂:CO molar ratio in the range of 1.9 to 2.3; and

synthesizing liquid hydrocarbon from the synthesis gas by Fischer-Tropsch synthesis.

Moreover, according to the present invention, the excess of hydrogen separated from the synthesis gas can be used as fuel in the step of steam reforming, and carbon dioxide separated from the synthesis gas can be mixed with natural gas and fed at an inlet of the steam reforming reactor.

According to the present invention, the steam reforming is carrying out preferably at a pressure of a natural gas-steam mixture in the range of 22 to 35 bars.

The main technical result provided by the present invention is ensuring sufficiently high carbon efficiency without the use of expensive and power-consuming equipment for separation of CO₂ from combustion gas. Moreover, the present invention substantially excels the known process of the above-mentioned U.S. Pat. No. 6,881,394 in carbon efficiency.

### BRIEF DESCRIPTION OF THE DRAWINGS

FIG. 1 shows a flow chart of the process for producing liquid hydrocarbons from natural gas according to the above-mentioned article by I. S. Ermolaev et al.

FIG. 2 shows a flow chart of the process for producing liquid hydrocarbons from natural gas according to the above-mentioned U.S. Pat. No. 6,881,394 B2;

FIG. 3 shows a flow chart of the process for producing liquid hydrocarbons from natural gas according to the present invention.

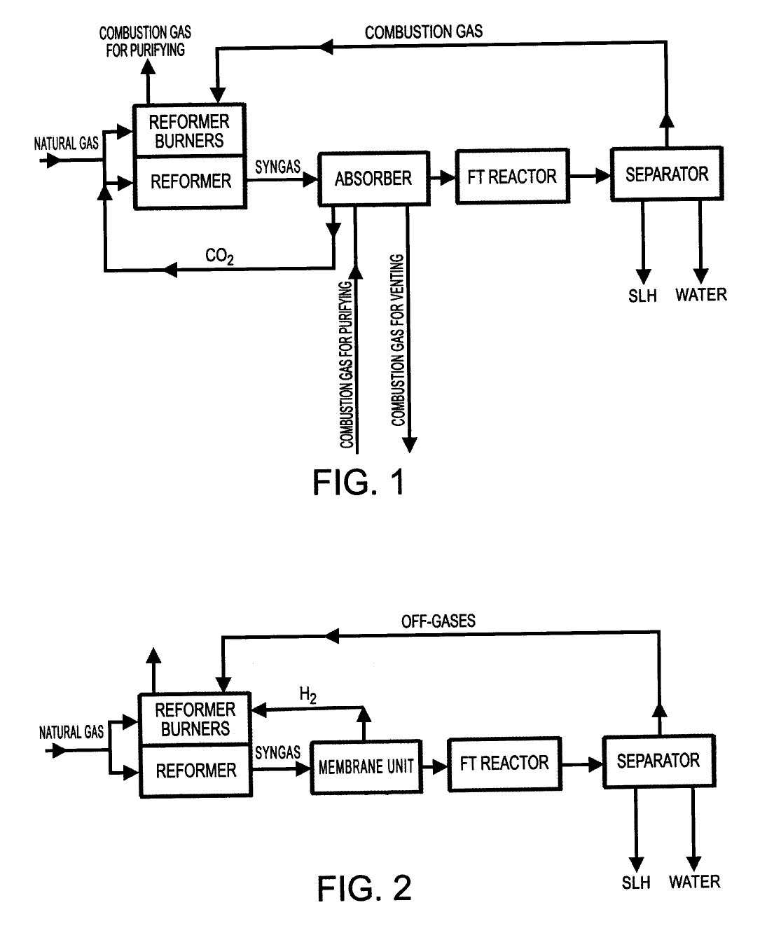

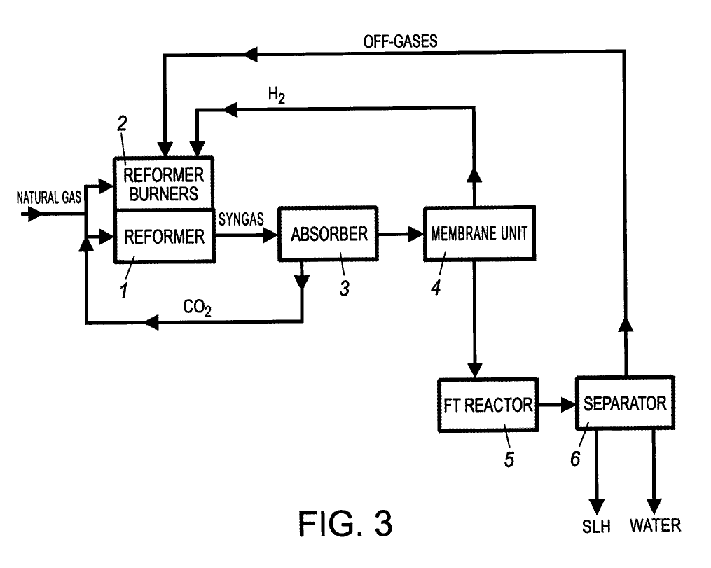

### DETAILED DESCRIPTION OF THE INVENTION

The process of the present invention is carried out in the following way.

Steam reforming of natural gas is carried out in a reformer 1 (steam reforming reactor) having burners 2 so that synthesis gas (herein also referred as to “syngas”) with a H₂:CO molar ratio of about 2.4 to 2.8 and CO₂ content of about 18% is produced. This syngas is fed to an absorption unit 3 (referred to as “absorber” in Figures) for separation of CO₂ from syngas to residual CO₂ content no more than 5 vol. % by a liquid absorption method. Present-day technologies of CO₂ separation are based on liquid absorption by amine solutions (such as methyldiethanolamine (MDEA), diethanolamine or complex amines) or potash solution. All these solutions enable achieving an equal result and MDEA is the most common due to commercial successes of BASF that offered MDEA. CO₂ separated from syngas is mixed with natural gas supplied in a tube side of the reformer 1. Syngas purified of CO₂ is passed over hydrogen-permeable membranes of a membrane unit 4 to separate excess hydrogen whereby syngas having H₂:CO molar ratio of 1.9 to 2.3 is produced. Syngas is then fed to a Fischer-Tropsch reactor 5 (referred to as “FT reactor” in the Figures and the following Examples) in which synthetic liquid hydrocarbons are produced from syngas. Fischer-Tropsch synthesis off-gases separated in a separator 6 are supplied as fuel gas to the burners 2 of the reformer 1 where the off-gases partially replace natural gas intended to burn in the burners 2. Hydrogen separated by the membrane unit 4 is also supplied to the burners 2 for partial substitution of natural gas as fuel gas. Supply of CO₂ separated from syngas in the tube side of the reformer 1 enables to shift reforming reaction equilibrium so that the H₂:CO molar ratio in the range of 2.4 to 2.8 is achieved.

In the process of the present invention, although the amount of CO₂ separated from syngas is insufficient to provide the required H₂:CO molar ratio of 2 directly in the reformer 1, the absorption unit 3 according to the present invention is more than twice as small and cheap as an amine treatment unit in the process by I. S. Ermolaev et al. Therefore, at the outlet of the reformer 1 according to the present invention, there is a syngas with a H₂:CO molar ratio of 2.4 to 2.8 and moderate CO₂ amount that is then separated in the absorber 3. The content of excess hydrogen in the syngas after steam reforming is also substantially lower than in the process of U.S. Pat. No. 6,881,394 and so the membrane unit 4 is accordingly smaller in sizes and cheaper. Moreover, the combination of the absorption unit 3 and the membrane unit 4 enables producing low-CO₂ syngas without the use of expensive separation of CO₂ from combustion gas. Moreover, the process of the present invention enables use of more structurally and technologically simple and cheap amine treatment variants in which CO₂ is separated from syngas to a residual content no more than 5 vol. % with no substantial loss of Fischer-Tropsch synthesis efficiency.

It should be noted that for the purposes of the present invention it is important that the hydrogen separation by membranes should be carried out not until the syngas has been purified of carbon dioxide but not vice versa. According to the invention, the combination of steam reforming and liquid separation of carbon dioxide yields syngas having a minor hydrogen excess. This excess can be separated and removed easily by the membrane unit 4 of small capacity when the separated hydrogen amount is just enough to cover fuel gas needs of the reformer 1 (hydrogen covers a part of the needs whereas the rest needs are covered by off-gases from the Fischer-Tropsch reactor 5). If membrane treatment in the unit 4 is carried out before absorption in the unit 3, the membranes of the unit 4 will be forced to process carbon dioxide rich syngas characterized by lower hydrogen partial pressure. It was found that in such case the required hydrogen recovery rate either cannot be achieved or is achieved at lower selectivity, i.e. hydrogen is separated together with carbon dioxide and no longer utilizable as fuel gas in a steam reforming reactor.

As provided by the present invention, the combination of the reformer 1, the undersized absorption unit 3 and the undersized membrane unit 4 placed thereafter creates an unexpected and superadditive effect enabling achievement of the main technical result of the present invention, namely achievement of sufficiently high carbon efficiency without the use of expensive equipment for CO₂ separation from combustion gas. Moreover, the process of the present invention enables to eliminate the problem of oxygen contained in the amine solution (because CO₂ is not separated from combustion gas of the reformer 1), eliminate necessity of consumption of an additional natural gas as fuel gas for reforming burners, substantially reduce of hydrogen amount used as fuel gas for reforming burners (hydrogen combustion is energy-wise disadvantageous versus combustion of natural gas or off-gases from Fischer-Tropsch synthesis) and use of the more simplified and inexpensive absorption unit 3 for separating CO₂ from syngas to residual CO₂ content no more than 5 vol. %.

According to the present invention, steam reforming reaction is preferably carried out under a pressure in the range of 22 to 35 bars. At a pressure below 22 bars, carrying out effective Fischer-Tropsch synthesis becomes impossible because syngas pressure at an inlet of the Fischer-Tropsch reactor 5 can be provided at a level only below 18 bars resulting in sharp falloff in productivity of the catalyst used in Fischer-Tropsch synthesis. At a pressure above 35 bars, weight and cost of the equipment for steam reforming and liquid absorption substantially increase.

Hereinafter, embodiments of processes for producing synthetic liquid hydrocarbons from natural gas are provided wherein Examples 1 to 4 illustrate implementation of the present invention process whereas Examples 5 to 9 are given as comparisons with the present invention process.

### EXAMPLE 1

Natural gas containing 96% of methane was fed under a pressure of 25 bars for mixing with water steam at a steam:gas volume ratio of 2.55. The resulting steam-gas mixture was fed in the tube side of the reformer 1 where, over a nickel catalyst, the steam-gas mixture was converted to syngas. After separation of unreacted water from syngas, H₂:CO molar ratio in the produced syngas was 2.8 and CO₂ content was 12%. This syngas was fed to the absorption unit 3 (amine treatment absorber) where CO₂ was separated by means of MDEA solution to a residual content of 0.5%. Rich amine (MDEA) solution was fed to a regenerator (not shown in Figs.) where CO₂ was released at a temperature above 115° C. The released CO₂ gas was compressed to a pressure of 24 bars and fed for mixing with the steam-gas mixture at an inlet of the reformer 1. Syngas purified of CO₂ was passed over polymer hydrogen-permeable membranes of the membrane unit 4 thereby excess hydrogen was separated and syngas with a H₂:CO molar ratio of 2.2 was produced. This syngas was fed to the Fischer-Tropsch reactor 5 where synthetic liquid hydrocarbons (SLH) were produced over a cobalt catalyst. Products of Fischer-Tropsch synthesis are SLH, water and off-gases. Off-gases were mixed with hydrogen separated by the membranes and supplied for burning in the burners 2 of the reformer 1 to generate heat required for maintaining endothermic steam reforming reaction. An integral carbon efficiency of the process was 50%.

Processes of Examples 2 to 4 according to the present invention and comparative Examples 5, 6 were carried out similar to Example 1. Comparative Example 7 show results of carrying out the process for producing liquid hydrocarbons according to I. S. Ermolaev at al. and comparative Examples 8, 9 show results of carrying out the process according to U.S. Pat. No. 6,881,394. Quantitative data for all Examples 1 to 9 are given in Table. A temperature of syngas at an outlet of the reformer tubes was 880° C. in all Examples except for Examples 4 and 9.

TABLE

| | | | H₂:CO | | | |
|---|---|---|---|---|---|---|
| | Steam | H₂:CO | at the | CO₂ at | | |
| | reforming | at the | FT | the FT | Carbon | |
| Example | pressure, | reformer | reactor | reactor | efficiency, | |
| number | bar | outlet | inlet | inlet % | % | Note |
| 1 | 25 | 2.8 | 2.2 | 0.2 | 50 | The present |
| | | | | | | invention |
| 2 | 35 | 2.7 | 2.2 | 0.2 | 46 | The present |
| | | | | | | invention |
| 3 | 25 | 2.7 | 2.2 | 5.0 | 46 | The present |
| | | | | | | invention |
| 4 | 25 | 2.6 | 2.2 | 0.2 | 57 | The present |
| | | | | | | invention * |
| 5 | 18 | 2.7 | 2.2 | 0.2 | 39 | Out of the |
| | | | | | | scope of |
| | | | | | | the present |
| | | | | | | invention |
| 6 | 40 | 2.4 | 2.0 | 0.5 | 38 | Out of the |
| | | | | | | scope of |
| | | | | | | the present |
| | | | | | | invention |
| 7 | 25 | 2.2 | 2.2 | 0.3 | 50 | According |
| | | | | | | to I.S. |
| | | | | | | Ermolaev |
| | | | | | | at al. |
| 8 | 25 | 4.3 | 2.2 | 11 | 29 | According |
| | | | | | | to U.S. |
| | | | | | | Pat. No. |
| | | | | | | 6,881,394 |
| 9 | 25 | 3.6 | 2.2 | 6 | 39 | According |
| | | | | | | to U.S. |
| | | | | | | Pat. No. |
| | | | | | | 6,881,394 * |

* With use of an expensive reformer having improvement characteristics (a temperature of syngas at the outlet of the reformer tubes was 1,000° C., a steam:gas ratio was 2.1).

1. A process for producing synthetic liquid hydrocarbons from natural gas, the process comprising subsequent steps of:
steam reforming of natural gas in a steam reforming reactor to form synthesis gas;
separating carbon dioxide from the synthesis gas by a liquid absorption method to provide a remaining carbon dioxide content in the synthesis gas no more than 5 vol. %;
separating an excess of hydrogen from the synthesis gas by using a hydrogen-permeable membrane apparatus to provide a H2:CO molar ratio in the range of 1.9 to 2.3; and
synthesizing liquid hydrocarbon from the synthesis gas by Fischer-Tropsch synthesis.

2. The process of claim 1 wherein the excess of hydrogen separated from the synthesis gas is used as fuel in the step of steam reforming.

3. The process of claim 1 wherein carbon dioxide separated from the synthesis gas is mixed with natural gas and fed at an inlet of the steam reforming reactor.

4. The process of claim 1, wherein the steam reforming is carrying out at a pressure of a natural gas-steam mixture in the range of 22 to 35 bars.
